(19) United States
(12) Patent Application Publication
(10) Pub. No.: US 2018/0026878 A1
(43) Pub. Date: Jan. 25, 2018

(54) SCALABLE DEADLOCK-FREE DETERMINISTIC MINIMAL-PATH ROUTING FOR DRAGONFLY NETWORKS

(71) Applicants: MELLANOX TECHNOLOGIES TLV LTD., Ra'anana (IL); UNIVERSIDAD DE CASTILLA-LA MANCHA, Albacete (ES)

(72) Inventors: Eitan Zahavi, Zichron Yaakov (IL); German Maglione-Mathey, Albacete (ES); Pedro Yebenes, Albacete (ES); Jesus Escudero-Sahuquillo, Albacete (ES); Pedro Javier Garcia, Albacete (ES); Francisco Jose Quiles, Albacete (ES)

(21) Appl. No.: 15/218,028

(22) Filed: Jul. 24, 2016

(51) Int. Cl. H04L 12/721; H04L 12/733; H04L 12/751; H04L 12/713

(52) U.S. Cl. CPC H04L 45/38; H04L 45/586; H04L 45/122; H04L 45/02

(57) ABSTRACT

A communication apparatus includes an interface and a processor. The interface is configured for connecting to a communication network, including multiple network switches divided into groups. The processor is configured to predefine a strictly monotonic order among the groups, to receive an indication of a flow of packets to be routed from a source endpoint served by a source network switch belonging to a source group to a destination endpoint served by a destination network switch belonging to a destination group, to assign a first Virtual Lane (VL) to the packets in the flow if the destination group succeeds the source group in the predefined order, to assign to the packets in the flow a second VL if the destination group does not succeed the source group in the predefined order, and to configure the network switches to route the packets of the flow in accordance with the assigned VL.

### FIELD OF THE INVENTION

The present invention relates generally to interconnection networks, and particularly to methods and systems for deadlock-free routing in high-performance interconnection networks.

### BACKGROUND OF THE INVENTION

Various techniques for routing packets in interconnection networks are known in the art. Some routing schemes employ means for avoiding routing loops that potentially cause deadlocks. Such schemes are described, for example, by Dally and Seitz, in “Deadlock-Free Message Routing in Multiprocessor Interconnection Networks,” IEEE Transactions on Computers, volume C-36, no. 5, May, 1987, pages 547-553, which is incorporated herein by reference.

Some routing schemes are designed for Dragonfly-topology networks. The Dragonfly topology and example routing algorithms are described, for example, by Kim et al., in “Technology-Driven, Highly-Scalable Dragonfly Topology,” Proceedings of the 2008 International Symposium on Computer Architecture, Jun. 21-25, 2008, pages 77-88, which is incorporated herein by reference.

Dragonfly topologies, as well as other topologies, can be built from components based on the InfiniBand (IB) specification, which defines an input/output architecture used to communicate computing and/or storage servers using high-performance interconnection networks. The IB architecture is currently the predominant interconnect technology for supercomputers.

### SUMMARY OF THE INVENTION

An embodiment of the present invention that is described herein provides a communication apparatus including an interface and a processor. The interface is configured for connecting to a communication network, which includes multiple network switches that are divided into groups. The processor is configured to predefine a strictly monotonic order among the groups, to receive an indication of a flow of packets to be routed from a source endpoint served by a source network switch belonging to a source group to a destination endpoint served by a destination network switch belonging to a destination group, to assign a first Virtual Lane (VL) to the packets in the flow if the destination group succeeds the source group in the predefined order, to assign to the packets in the flow a second VL, different from the first VL, if the destination group does not succeed the source group in the predefined order, and to configure the network switches to route the packets of the flow in accordance with the assigned VL.

In some embodiments, any pair of the groups is connected by at least one direct inter-group link. In some embodiments, the processor is configured to prevent a deadlock in routing of the flow, while causing the network switches to apply minimal-path routing to the flow and to retain the assigned VL throughout routing of the flow from the source endpoint to the destination endpoint. In an example embodiment, the processor is configured to assign to all flows across the communication network no more than the first and second VLs. In a disclosed embodiment, the processor is configured to improve routing performance by assigning a third VL, different from the first and second VLs, to another flow of packets.

There is additionally provided, in accordance with an embodiment of the present invention, a method for communication. The method includes, in a communication network, which includes multiple network switches that are divided into groups, predefining a strictly monotonic order among the groups. An indication of a flow of packets to be routed from a source endpoint served by a source network switch belonging to a source group, to a destination endpoint served by a destination network switch belonging to a destination group, is received. If the destination group succeeds the source group in the predefined order, a first Virtual Lane (VL) is assigned to the packets in the flow. If the destination group does not succeed the source group in the predefined order, a second VL, different from the first VL, is assigned to the packets in the flow. The packets of the flow are routed via the communication network in accordance with the assigned VL.

There is further provided, in accordance with an embodiment of the present invention, a communication system including multiple network switches that are divided into groups, and a processor. The processor is configured to predefine a strictly monotonic order among the groups, to receive an indication of a flow of packets to be routed from a source endpoint served by a source network switch belonging to a source group to a destination endpoint served by a destination network switch belonging to a destination group, to assign a first Virtual Lane (VL) to the packets in the flow if the destination group succeeds the source group in the predefined order, to assign to the packets in the flow a second VL, different from the first VL, if the destination group does not succeed the source group in the predefined order, and to configure the network switches to route the packets of the flow in accordance with the assigned VL.

There is also provided, in accordance with an embodiment of the present invention, a computer software product, the product including a tangible non-transitory computer-readable medium in which program instructions are stored, which instructions, when read by one or more processors in a communication network, which includes multiple network switches that are divided into groups, cause the processors to predefine a strictly monotonic order among the groups, to receive an indication of a flow of packets to be routed from a source endpoint served by a source network switch belonging to a source group to a destination endpoint served by a destination network switch belonging to a destination group, to assign a first Virtual Lane (VL) to the packets in the flow if the destination group succeeds the source group in the predefined order, to assign to the packets in the flow a second VL, different from the first VL, if the destination group does not succeed the source group in the predefined order, and to configure the network switches to route the packets of the flow in accordance with the assigned VL.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a Dragonfly-topology network, in accordance with an embodiment of the present invention; and

FIG. 2 is a flow chart that schematically illustrates a method for routing in a Dragonfly-topology network, in accordance with an embodiment of the present invention.

### DETAILED DESCRIPTION OF EMBODIMENTS

### Overview

Embodiments of the present invention that are described herein provide improved methods and system for routing packets over interconnection networks having Dragonfly topology. The disclosed techniques prevent routing loops that potentially cause deadlocks, even when the physical network topology contains closed loops.

In the disclosed embodiments, an interconnection network comprises multiple network switches, which are connected to one another, and to endpoints through network interfaces (NIs). In a Dragonfly topology the switches are divided into two or more groups, and the groups are interconnected by inter-group links, typically according to a fully-connected pattern. In other words, any two groups are connected by at least one direct inter-group link.

In some embodiments, the network operates in accordance with the Infiniband (IB) standard, and is managed by a Subnet Manager (SM) module. The SM may be implemented as a software module running on one or more of the endpoints or switches, or on a separate platform. Among other tasks, the SM receives indications of flows of packets to be routed via the network, and configures the switches and NIs for routing the flows. In particular, the SM assigns suitable Virtual Lanes (VLs) to the flows. The assignment of VLs has an impact on creation and prevention of loops and deadlocks, because each switch queues packets and applies flow control separately per VL.

In some embodiments, the SM predefines a strict monotonic order among the groups, e.g., assigns monotonically increasing indices to the groups. The SM receives an indication of a flow of packets that is to be routed from a source endpoint to a destination endpoint. The source endpoint is served by a switch that is referred to as a source switch, which belongs to a group that is referred to as a source group. The destination endpoint is served by a switch that is referred to as a destination switch, which belongs to a group that is referred to as a destination group.

The SM checks whether the destination group succeeds the source group in the predefined strictly monotonic order, e.g., whether the index of the destination group is larger than the index of the source group. If so, the SM assigns the flow a certain VL (e.g., VL=1). Otherwise, the SM assigns a different VL (e.g., VL=0) to the flow. The SM then configures the switches to forward the flow in question in accordance with the assigned VL. The flow may be routed, for example, using a suitable minimal-path routing algorithm.

The disclosed technique prevents deadlocks that may be caused by closed loops in the network, because no closed loop having the same VL can be formed. The small number of VLs, which is independent of the network size, makes the disclosed technique highly scalable. The disclosed routing technique is deterministic, in the sense that the routing path between pair of source and destination endpoints fixed, and not adapted in real-time by the switches. Moreover, the disclosed routing technique provides minimal-path routing, in the sense that the length of the path (i.e., the number of switch-to-switch hops from the source switch to the destination switch) is minimal.

It should also be noted that, when using the disclosed technique, the packets of the flows retain the same VL throughout the routing path from the source endpoint to the destination endpoint. This property is important, for example, in configurations in which the VLS are associated with respective Service Levels (SLs). In such configurations it may be unfeasible to modify the VL of a flow along the routing path.

### System Description

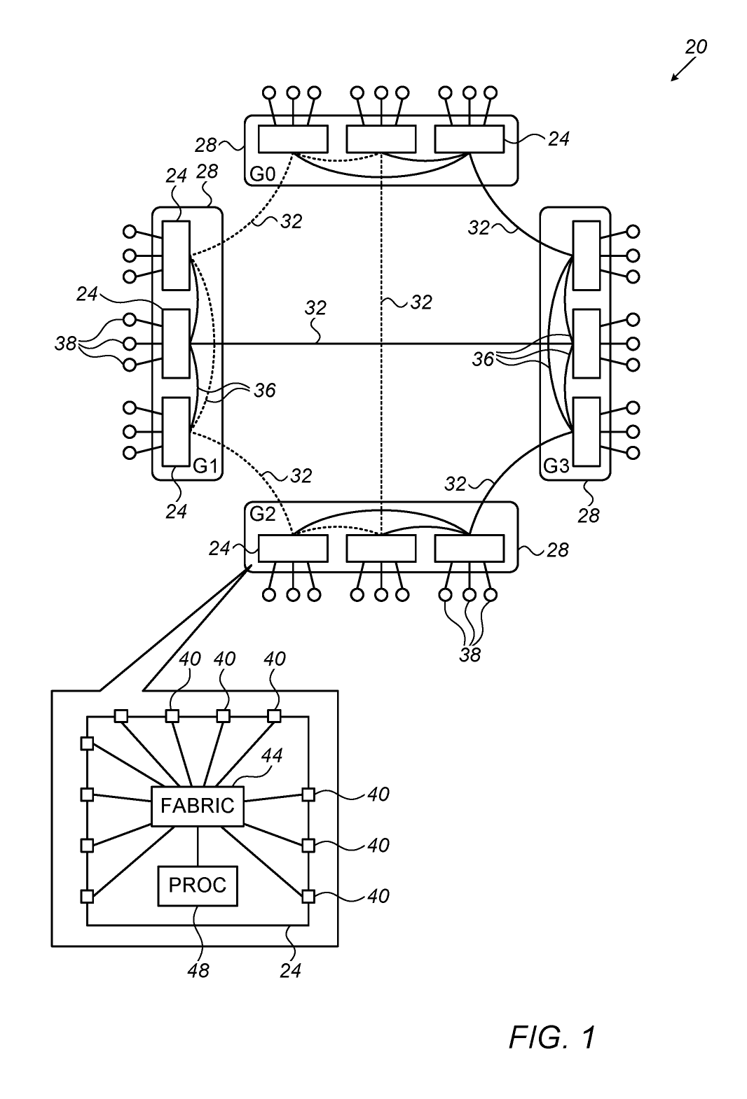

FIG. 1 is a block diagram that schematically illustrates a Dragonfly-topology network 20, in accordance with an embodiment of the present invention. Network 20 may comprise, for example, a data center, a High-Performance Computing (HPC) system or any other suitable type of network.

Network 20 comprises multiple network switches 24. Network 20 is used for routing flows of packets between endpoints 38, also referred to as clients.

Switches 24 are arranged in multiple groups 28. In the present example, network 20 comprises a total of four groups 28 denoted G0, G1, G2 and G3. Alternatively, however, any other suitable number of groups can be used. Groups 28 are connected to one another using network links 32, e.g., optical fibers, each connected between a port of a switch in one group and a port in a switch of another group. Links 32 are referred to herein as inter-group links or global links.

The set of links 32 is referred to herein collectively as an inter-group subnetwork or global subnetwork. In the disclosed embodiments, the inter-group subnetwork has an all-to-all, or fully-connected topology, i.e., every group 28 is connected to every other group 28 using at least one direct inter-group link 32. Put in another way, any pair of groups 28 comprise at least one respective pair of switches 24 (one switch in each group) that are connected to one another using a direct inter-group link 32. In yet other words, the topological distance between any two groups is one inter-group link.

The switches within each group 28 are interconnected by network links 36. Each link 36 is connected between respective ports of two switches within a given group 28. Links 36 are referred to herein as intra-group links or local links, and the set of links 36 in a given group 28 is referred to herein collectively as an intra-group subnetwork or local subnetwork.

In the present example, the local subnetwork in each group 28 is fully-connected. In other words, in each group 28, every two switches 24 are connected directly by at least one local link 36. This condition, however, is not mandatory. The disclosed techniques can be used with any other suitable intra-group subnetwork topology, e.g., fully-connected or not fully-connected, and loop-free or not.

An inset at the bottom-left of the figure shows a simplified view of the internal configuration of a switch 24, in an example embodiment. The other switches typically have a similar structure. In this example, switch 24 comprises multiple ports 40 for connecting to links 32 and/or 36 and/or endpoints 38, a switch fabric that is configured to forward packets between ports 40, and a processor 48 that carries out the methods described herein. In the context of the present patent application and in the claims, fabric 44 and processor 48 are referred to collectively as processing circuitry that carries out the disclosed techniques.

In the embodiments described herein, network 20 operates in accordance with the InfiniBand™ standard. Infiniband communication is specified, for example, in “InfiniBand™ Architecture Specification,” Volume 1, Release 1.2.1, November, 2007, which is incorporated herein by reference. In particular, section 7.6 of this specification addresses Virtual Lanes (VL) mechanisms, section 7.9 addresses flow control, and chapter 14 addresses subnet management (SM) issues. In alternative embodiments, however, network 20 may operate in accordance with any other suitable communication protocol or standard, such as IPv4, IPv6 (which both support ECMP) and “controlled Ethernet.”

In some embodiments, network 20 is associated with a certain Infiniband subnet, and is managed by a module referred to as a subnet manager (SM). The SM tasks may be carried out, for example, by software running on one or more of processors 48 of switches 24, on one or processors of endpoints 38, and/or on a separate processor. Typically, the SM configures switch fabrics 44, processors 48 in the various switches 24, and/or processors or NIs in endpoints 38, to carry out the methods described herein.

When the SM is implemented by software running on one or more of processors 48 of switches 24, then one or more of ports 40 of these switches serve as an interface that connects the SM to the network. When the SM is implemented on a separate processor of some computing platform, e.g., an endpoint 38, this platform typically comprises a suitable interface (e.g., NI) that connects the SM to the network. Any such implementation is suitable for carrying out the disclosed techniques by the SM.

The configurations of network 20 and switch 24 shown in FIG. 1 are example configurations that are depicted purely for the sake of conceptual clarity. In alternative embodiments, any other suitable network and/or switch configuration can be used. For example, groups 28 need not necessarily comprise the same number of switches, and each group 28 may comprise any suitable number of switches. The switches in a given group 28 may be arranged in any suitable topology.

The different elements of switches 24 and endpoints 38 may be implemented using any suitable hardware, such as in an Application-Specific Integrated Circuit (ASIC) or Field-Programmable Gate Array (FPGA). In some embodiments, some elements of switches 24 and endpoints 38 can be implemented using software, or using a combination of hardware and software elements. In some embodiments, the processors that carry out the disclosed techniques (e.g., processors 48 or processors in endpoints 38) comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Deterministic Deadlock-Free Minimal-Path Routing Scheme

As can be seen in FIG. 1, traffic between a pair of endpoints 38 can be routed over various paths in network 20, i.e., various combinations of local links 36 and global links 32. The topology of network 20 thus provides a high degree of path diversity that can be leveraged, for instance, for fault tolerance, and enables effective load balancing. This topology, however, comes at the price of closed loops that potentially cause deadlocks. An example of such a closed loop is shown using dashed lines in FIG. 1.

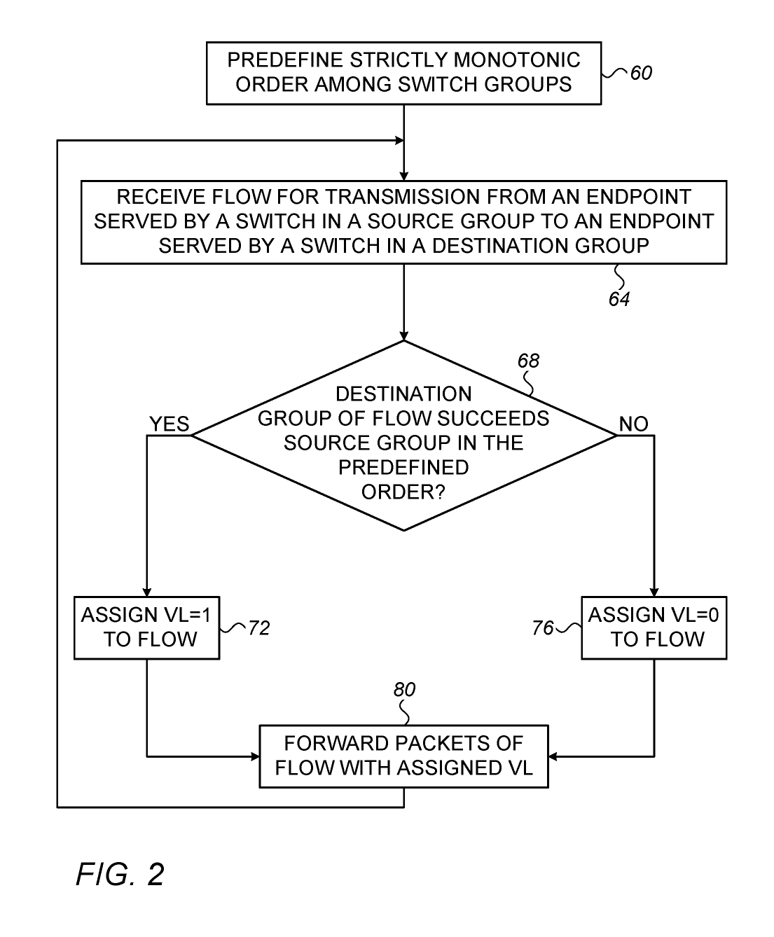

FIG. 2 is a flow chart that schematically illustrates a method for deadlock-free routing in Dragonfly-topology network 20, in accordance with an embodiment of the present invention. The method begins with the SM predefining a strict monotonic order among groups 28, at an order definition step 60. The term “strict monotonic order” refers to any order that, for any two groups, specifies unambiguously which group succeeds the other in the order.

In the present example, the SM predefines the strictly-monotonic order by assigning the groups monotonically-increasing indices. Alternatively, any other suitable order and/or any other suitable notation or indexing can be used, as long as strict monotonicity is maintained.

At a flow initiation step 64, the SM receives an indication of a flow of packets to be established. The flow in question originates at a certain source endpoint 38, and terminates at a certain destination endpoint 38. The source endpoint 38 is served by (and thus connected directly to) a switch 24 that is referred to as a source switch, which belongs to a group 28 that is referred to as a source group. The destination endpoint 38 is served by (and thus connected directly to) a switch 24 that is referred to as a destination switch, which belongs to a group 28 that is referred to as a destination group.

At an order-checking step 68, the SM checks whether the destination group succeeds the source group in the predefined strictly monotonic order. In the present example, the SM checks whether the index of the destination group is larger than the index of the source group.

If the destination group succeeds the source group in the predefined order, the SM assigns the flow a certain VL (e.g., VL=1), at a first VL assignment step 72. Otherwise, i.e., if the destination group does not succeed the source group in the predefined order, the SM assigns the flow a different VL (e.g., VL=0), at a second VL assignment step 76. Note that if the destination group and the source group are the same group, by definition the destination group does not succeed the source group in the predefined order, and step 76 is invoked.

At a forwarding step 80, the SM configures at least some of switches 24 to forward the flow in accordance with the assigned VL. The SM typically also configures the switches with the destination endpoint identifier (ID), which is used by the switches to obtain the output port 40 through which the packet is to be routed. The SM typically communicates with processors 48 of switches 24 for this purpose, and each processor 48 configures the respective fabric 44 as instructed by the SM. For instance, a certain fabric 44 may be configured in accordance with a linear forwarding table (LFT), which associates the ID of a destination endpoint 38 with a respective output port 40, in the case of deterministic routing.

Moreover, as part of the packet processing, fabric 44 in each switch typically applies flow-control separately per VL. For example, fabric 44 may queue the packets of each VL in a separate queue, and/or carry out credit-based flow control over a certain link separately per VL. As a result of the VL assignment described above, a closed routing path cannot be formed having the same VL, and therefore a physical loop cannot cause a deadlock.

The SM and switches 24 may use any suitable protocol and data structures for configuring the routing scheme. In the case of InfiniBand, for example, the SM discovers the network, addressing the NIs and switches by means of IDs. As mentioned before, IB switches typically implement LFTs that are populated by the SM in the network-discovery phase. After this phase all the LFTs at switches contain routing information. In an example embodiment, each VL used in network 20 is associated with a respective Service Level (SL), and each switch 24 comprises a SL-to-VL table that specifies this association. The SM also populates SL-to-VL tables in the network-discovery phase.

In InfiniBand networks, a packet belonging to a given traffic flow is assigned a SL prior to its injection into the network, based on the information computed by the SM. Actually, the SL will typically be assigned depending on its source endpoint ID and its destination endpoint ID. Therefore, every endpoint typically stores a copy of the SL information per ID, which is provided by the SM after the network-discovery stage. Once the packet is injected in the network, it will be stored in the VL according to its carrying SL and the information in the SL-to-VL tables.

The description above referred to a single flow and to two different VLs. In real-life implementations, however, network 20 routes a large number of flows simultaneously. In some embodiments, the SM uses only two VLs for routing all the flows across the network. This implementation uses only two VLs to eliminate deadlocks entirely, regardless of the number of switches or the number of groups.

In other embodiments, the SM may use a slightly larger number of VLs (e.g., three or four VLs) across the network (while still choosing between two possible VLs per flow as described above). A larger set of VLs is useful, for example, for mitigating congestion in addition to preventing deadlock due to loops. In an example embodiment, a third VL may be used only for intra-group communication, while the first and second VLs are used as described above. Although this technique is not mandatory for avoiding deadlocks, this use of a third VL for intra-group communication significantly reduces contention inside the group, since the three types of traffic flows that may be present in a group (traffic arriving from outside the group, traffic exiting the group, and traffic making an intra-group trip) are separated into different VLs (and thus queued and subjected to flow-control separately).

Although the embodiments described herein mainly address InfiniBand networks, SLs and VLs, the methods and systems described herein can also be used in other types of networks in which flow-control is applied to a flow at the level of a similar structure to VLs, i.e., a structure allowing separate queuing of flows based on some attribute or tag assigned to the flow (e.g., virtual channels). The disclosed techniques can be used in any suitable environment, e.g., environments in which (i) routing is deterministic and minimal-path, (ii) the network topology is a Dragonfly topology with fully-connected intergroup subnetworks (intra-group subnetwork may be blocking if it does not use a fully-connected pattern, but an additional VL would typically be needed to break the loops), and (iii) the use of VL assignment is unchanged along the packet route.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A communication apparatus, comprising:
an interface for connecting to a communication network, which comprises multiple network switches that are divided into groups; and
a processor, which is configured to predefine a strictly monotonic order among the groups, to receive an indication of a flow of packets to be routed from a source endpoint served by a source network switch belonging to a source group to a destination endpoint served by a destination network switch belonging to a destination group, to assign a first Virtual Lane (VL) to the packets in the flow if the destination group succeeds the source group in the predefined order, to assign to the packets in the flow a second VL, different from the first VL, if the destination group does not succeed the source group in the predefined order, and to configure the network switches to route the packets of the flow in accordance with the assigned VL.

2. The apparatus according to claim 1, wherein any pair of the groups is connected by at least one direct inter-group link.

3. The apparatus according to claim 1, wherein the processor is configured to prevent a deadlock in routing of the flow, while causing the network switches to apply minimal-path routing to the flow and to retain the assigned VL throughout routing of the flow from the source endpoint to the destination endpoint.

4. The apparatus according to claim 3, wherein the processor is configured to assign to all flows across the communication network no more than the first and second VLs.

5. The apparatus according to claim 3, wherein the processor is configured to improve routing performance by assigning a third VL, different from the first and second VLs, to another flow of packets.

6. A method for communication, comprising:
in a communication network, which comprises multiple network switches that are divided into groups, predefining a strictly monotonic order among the groups;
receiving an indication of a flow of packets to be routed from a source endpoint served by a source network switch belonging to a source group, to a destination endpoint served by a destination network switch belonging to a destination group;
if the destination group succeeds the source group in the predefined order, assigning a first Virtual Lane (VL) to the packets in the flow;
if the destination group does not succeed the source group in the predefined order, assigning to the packets in the flow a second VL, different from the first VL; and
routing the packets of the flow via the communication network in accordance with the assigned VL.

7. The method according to claim 6, wherein any pair of the groups is connected by at least one direct inter-group link.

8. The method according to claim 6, wherein assigning the first or second VL comprises preventing a deadlock in routing of the flow, while causing the network switches to apply minimal-path routing to the flow and to retain the assigned VL throughout routing of the flow from the source endpoint to the destination endpoint.

9. The method according to claim 8, and comprising assigning to all flows across the communication network no more than the first and second VLs.

10. The method according to claim 8, and comprising improving routing performance by assigning a third VL, different from the first and second VLs, to another flow of packets.

11. A communication system, comprising:
multiple network switches that are divided into groups; and
a processor, which is configured to predefine a strictly monotonic order among the groups, to receive an indication of a flow of packets to be routed from a source endpoint served by a source network switch belonging to a source group to a destination endpoint served by a destination network switch belonging to a destination group, to assign a first Virtual Lane (VL) to the packets in the flow if the destination group succeeds the source group in the predefined order, to assign to the packets in the flow a second VL, different from the first VL, if the destination group does not succeed the source group in the predefined order, and to configure the network switches to route the packets of the flow in accordance with the assigned VL.

12. The communication network according to claim 11, wherein any pair of the groups are connected by at least one direct inter-group link.

13. The communication network according to claim 11, wherein the processor is configured to prevent a deadlock in routing of the flow, while causing the network switches to apply minimal-path routing to the flow and to retain the assigned VL throughout routing of the flow from the source endpoint to the destination endpoint.

14. A computer software product, the product comprising a tangible non-transitory computer-readable medium in which program instructions are stored, which instructions, when read by one or more processors in a communication network, which comprises multiple network switches that are divided into groups, cause the processors to predefine a strictly monotonic order among the groups, to receive an indication of a flow of packets to be routed from a source endpoint served by a source network switch belonging to a source group to a destination endpoint served by a destination network switch belonging to a destination group, to assign a first Virtual Lane (VL) to the packets in the flow if the destination group succeeds the source group in the predefined order, to assign to the packets in the flow a second VL, different from the first VL, if the destination group does not succeed the source group in the predefined order, and to configure the network switches to route the packets of the flow in accordance with the assigned VL.
